(19) United States
(12) Patent Application Publication
(10) Pub. No.: US 2009/0116059 A1
(43) Pub. Date: May 7, 2009

(54) PRINTING APPARATUS COMPRISING A PRINT MODULE AND A FINISHING MODULE

(76) Inventors: Ronald W. C. M. BUSKENS, Weert (NL); Joannes C.J. Cornelissen, Roermond (NL)

Correspondence Address: BIRCH STEWART KOLASCH & BIRCH, PO BOX 747, FALLS CHURCH, VA, 22040-0747, US

(21) Appl. No.: 12/263,043

(22) Filed: Oct. 31, 2008

(30) Foreign Application Priority Data
Nov. 5, 2007 (EP) EP 07119996.2

(51) Int. Cl. G06F 3/12

(52) U.S. Cl. 358/1.15

(57) ABSTRACT

A printing apparatus with a print module and a finishing module, in which three delivery timing parameters communicate between the finishing module and the print module via an interface which is designed in such a way that only information bits are passed, resulting in an errorless finishing of sets of sheets.

This non-provisional application claims priority under 35 U.S.C. §119(a) on European Patent Application No. 07119996.2 filed in the European Patent Office on Nov. 5, 2007, which is herein incorporated by reference

### BACKGROUND OF THE INVENTION

The present invention relates to a method for printing one or more sets, each set consisting of one or more sheets of a receiving medium, each sheet having a leading edge and a trailing edge, and for carrying out user selectable finishing operations on said one or more sets.

Methods for printing and finishing sets on a printing apparatus, comprising a print module and a finishing module connected to the print module, are generally known. A sheet processed in the printing apparatus may be a paper sheet or may be a sheet of any other kind of suitable print medium. Sets of sheets are processed in the print module and each sheet has a leading edge and a trailing edge, where the leading edge of the sheet leaves the print module first in time and the trailing edge leaves the print module last in time. Also the leading edge of the sheet enters the finishing module first in time and the trailing edge enters the finishing module last in time. The set of sheets is finished in the finishing module. Finishing options include, but are not limited to stitching, binding, folding, drilling, perforating or any combination of the mentioned finishing options.

Normally the finishing module is positioned in such a way that the sheets are enabled to easily flow from an outlet of the print module to an inlet of the finishing module. Communication between the print module and the finishing module is necessary to let the printing apparatus succeed in an errorless printing and finishing of a set of sheets or consecutive sets of sheets. When a finishing module is used, this printing module has to be adapted to the capabilities of the finishing module, e.g., the finishing velocity per sheet. Such a printing module is known from U.S. Pat. No 6,741,817. In U.S. Pat. No. 6,741,817 the interaction between the print module and the finishing module is achieved by a communication interface in the print module and a communication interface in the finishing module, both interfaces being operatively connected through a communication cable. For each sheet, processing information is sent from the print module to the finishing module. The finishing module determines preparation completion information, such as a period in time needed by the finishing module to finish the sheet based on the processing information. The preparation completion information is sent to the print module just before the image forming process starts. Disadvantageously, the processing information is comprehensive, comprises a lot of parameters and therefore takes a relatively long period in time to be communicated for each sheet to be printed and finished.

### SUMMARY OF THE INVENTION

An object of the present invention is to provide a method for printing and finishing one or more sets in a printing apparatus, wherein the communication between the print module and the finishing module is designed in a straightforward, simple and time efficient manner. The object is achieved in a method comprising the steps of storing at least one predetermined delivery timing parameter in a finisher memory of the finishing module, storing said at least one predetermined delivery timing parameter in a printer memory of the print module, printing a set of said one or more sets in the print module while taking said at least one predetermined delivery timing parameter into account, and finishing said set of said one or more sets in the finishing module while taking said at least one predetermined delivery timing parameter into account.

To let the process of printing and finishing of one or more sets seamlessly link, one or more predetermined delivery timing parameters are stored in the finishing module as well as in the print module before printing and finishing of the sets starts. In this way the finishing module does not have to send one or more predetermined delivery timing parameters to the print module for every sheet to be processed. By storing the delivery timing parameters in the finishing module and print module, delivery timing parameter data can be passed from the finishing module to the printing module in a simpler way, since the possible values of the delivery timing parameters are known to both modules. By passing delivery timing parameter data from the finishing module to the print module, the print module is enabled to be adapted to the needs of the finishing module. In that case the finishing module is the bottleneck in the process chain “printing-finishing”. If the finishing module is faster than the print module the print module is the bottleneck in the process chain “printing-finishing” and the direction of passing the delivery timing parameter data is the other way around, that is, the delivery timing parameter data goes from print module to finishing module. In this sequel the finishing module is supposed to be the bottleneck. However, if under certain conditions the finishing module is able to process sheets of sets faster than the print module is able to deliver the sheets of sets, the finishing module is assumed to decrease his processing speed to be in line with the processing speed of the print module.

In one embodiment a set to be printed and finished needs one or more of the stored predetermined delivery timing parameters to let the printing and finishing process run in a harmonized way. The needed delivery timing parameters are read from the finisher memory of the finishing module and passed to the print module before printing starts. On the print module the delivery timing parameters are read and printing of the set starts taking the delivery timing parameters into account. In this way the print module takes care of the delays, requested by the finishing module. Also the finishing of the set takes the delivery timing parameters into account. The finishing module knows, for example, at what time the print module starts processing a subsequent sheet and at what time the subsequent sheet is ready to be finished in the finishing module. The passing of the delivery timing parameters may take place by means of a connection cable, a wireless connection, infrared beams or any other data transport mechanism. In one embodiment an operator may supply the delivery timing parameters based on specifications of the printing module and/or the finishing module.

In another embodiment it is possible that the finishing of a sheet is done in a minimum finishing time, which is longer than the minimum print time to print the sheet. In this case the minimum print time of a sheet is lower than the minimum finishing time of a sheet. To avoid paper jams in the print module, in the finishing module or in between the print module and the finishing module, the minimum print time of a sheet has to be tuned to the minimum finishing time by increasing the minimum print time of a sheet. To determine the right print time to process a sheet in the print module a first delivery timing parameter is defined. The value of the first delivery timing parameter corresponds to a time interval between the receipt by the finishing module of the leading edge of a sheet of a first set of one or more sets and the leading edge of a subsequent sheet of the set, called the minimum sheet interval time. The printing module should respect this minimum sheet interval time in order to prevent a paper jam.

In a further embodiment at least two values may be set for the first delivery timing parameter: a default minimum sheet interval time and an optional minimum sheet interval time. The default minimum sheet interval time and the optional minimum sheet interval time may be supplied via a print module console of the print module and may be stored in a printer memory of the print module. Also the default minimum sheet interval time and the optional minimum sheet interval time may be supplied via a finishing module console of the finishing module and may be stored in a finisher memory of the finishing module. If a request for the optional minimum sheet interval time is activated, the printing module will use the optional sheet interval time as soon as possible. For sheets already in process the print module may still use the default minimum sheet interval time. If the request for the optional minimum sheet interval time is deactivated, the printing module may use the default minimum sheet interval time as soon as possible. For sheets already in process the printing module may still use the optional sheet interval time.

In an embodiment, in which finishing of a set is done in a minimum time by the finishing module, the following situation can be distinguished amongst others, hereinafter referred to as consecutive processing of sets. Consecutive processing of sets is a situation in which a set of sheets is printed in the print module, the printed set as a whole is finished on the finishing module and during the finishing of the set, the finishing module cannot receive sheets for a subsequent set. An example may be a booklet-maker, which may need a certain time to staple and fold a booklet while it cannot receive sheets of the following set. For such a situation a delay between sets may be increased in response to and based on a second delivery timing parameter. The value of the second delivery timing parameter corresponds to a time interval between the receipt by the finishing module of the trailing edge of a last sheet of a set of one or more sets and the leading edge of a first sheet of the subsequent set of said one or more sets, hereinafter referred to as a minimum delay between sets.

In an embodiment at least two values may be set for the second delivery timing parameter: a default minimum delay between sets and an optional minimum delay between sets. The default minimum delay between sets and the optional minimum delay between sets may be supplied via a print module console of the print module and stored in a printer memory of the print module. Also the default minimum delay between sets and the optional minimum delay between sets may be supplied via a finishing module console of the finishing module and may be stored in a finisher memory of the finishing module. If a request for the optional minimum delay between sets is activated, the printing module may use the optional minimum delay between sets as soon as possible. For sets already in process the print module may still use the default minimum delay between sets. If the request for the optional minimum delay between sets is deactivated, the printing module may use the default minimum delay between sets as soon as possible. For sets already in process the printing module may still use the optional minimum delay between sets.

In an embodiment, where finishing of a set is done in a minimum time by the finishing module, the following situation can be distinguished amongst others, hereinafter referred to as parallel processing of sets. Parallel processing of sets is a situation in which a set of sheets is printed in the print module, the printed set is finished on the finishing module and during the finishing of the set, the finishing module may receive sheets of the following set. An example may be a glue-binder, which may need a certain time to glue a set while it can receive sheets for a subsequent set. For such a situation the minimum set interval time may be increased in response to and based on a third delivery timing parameter. The value of the third delivery timing parameter corresponds to a time interval between the receipt by the finishing module of the trailing edge of a last sheet of a set of one or more sets and the leading edge of a last sheet of a subsequent set of said one or more sets, hereinafter referred to as a minimum set interval time.

In an embodiment only two values can be set for the third delivery timing parameter: a default minimum set interval time and an optional minimum set interval time. The default minimum set interval time and the optional minimum set interval time may be supplied via a print module console of the print module and may be stored in a printer memory of the print module. Also the default minimum set interval time and the optional minimum set interval time may be supplied via a finishing module console of the finishing module and may be stored in a finisher memory of the finishing module. If a request for the optional minimum set interval time is activated, the printing module may use the optional minimum set interval time as soon as possible. For sets already in process the print module may still use the default minimum set interval time. If the request for the optional minimum set interval time is deactivated, the printing module may use the default minimum set interval time as soon as possible. For sets already in process the printing module may still use the optional minimum set interval time.

In an embodiment a set to be printed and finished may need one or more of the stored predetermined delivery timing parameters to let the printing and finishing process run in a harmonized way. One of the finishing module and the print module operates as a sending module and the other one module operates as a receiving module. The sending module comprises a sender memory and the receiving module comprises a receiver memory. In the case where the finishing module operates as the sending module, the sender memory comprises the finisher memory and the receiver memory comprises the printer memory. In the case where the finishing module operates as the receiving module, the receiver memory comprises the finisher memory and the sender memory comprises the printer memory. A number of locations in the sender memory of the sending module are determined, each location storing at least one delivery timing parameter. On the sending module at least one reference parameter is defined corresponding to these locations. At least one defined reference parameter is passed from the sending module to the receiving module before printing of a set starts. On the receiving module at least one passed reference parameter is used to identify the corresponding locations in the receiver memory storing the corresponding predetermined delivery timing parameters and printing of the set starts taking these delivery timing parameters into account. Because of the definition of reference parameters the amount of data to be passed from the sending module to the receiving module is considerably reduced. If in the processing chain “printing-finishing” the finishing process limits a number of sheets processed per unit time in the processing chain, the direction of the passing of the reference parameters may be from the finishing module towards the print module, in other words the finishing module may operate as the sending module and the print module may operate as the receiving module. If in the processing chain “printing-finishing” the printing process limits a number of sheets processed per unit time in the processing chain, the direction of the passing of the reference parameters may be from the print module towards the finishing module, in other words the print module may operate as the sending module and the finishing module may operate as the receiving module.

In an embodiment a reference parameter which is passed from the sending module to the receiving module comprises a number of digits, each digit having a value one or zero, suitable for identifying one or more locations in the receiver memory storing the predetermined delivery timing parameters. The number of digits which are used depends, for example, on the number of predetermined delivery timing parameters and the number of selectable values per delivery timing parameter. By defining the reference parameters by a number of digits, each digit having a value one or zero, the interface between the sending module and the receiving module is simple and easy to implement. Mentioned binary digits may be replaced by any other digits, for example, hexadecimal digits or digits based on any other number base.

In an embodiment the reference parameter comprises a number of digits suitable for identifying the locations in the receiving memory storing the predetermined delivery timing parameters, where the number of digits is selected as small as possible. For example, as described above, a collection of two values for each of three delivery timing parameters, e.g., a predetermined default value and a predetermined optional value for each of the three delivery timing parameters, results in a collection of six possible values of the three delivery timing parameters. One reference parameter may be defined for each of the three delivery timing parameters, the reference parameter being a binary number of one digit, having the value zero or one. Thus a minimum number of three digits results in a fast passing of the reference parameters from the sending module to the receiving module and a simple implementation of the interpretation of the digits by the receiving module. The passing, for example, takes place via a connector between the sending module and the receiving module, which may be for example a connector with male and female contacts. In case of such, connector pins can have a number of voltage levels, which may determine the number of pins necessary to be dedicated for the passing of the reference parameters. In the case of only two voltage levels, each voltage level can be mapped on a value of a digit of the binary number of three digits and three pins may be needed to pass the reference parameters. In case of a pin with eight voltage levels we may need only one pin, since two to the power of three possibilities exist to indicate a value zero or a value one for each of the locations in sender memory of the three delivery timing parameters. Above mentioned implementation of the interface results in quick information transfer between the sending module and the receiving module.

### BRIEF DESCRIPTION OF THE DRAWINGS

The present invention will now be further explained with reference to the appended drawings showing non-limiting embodiments, wherein:

FIG. 1 is a diagram showing a printing apparatus with a print module and a finishing module, and

FIG. 2 is a diagram showing the inter sheet and set timing.

### DETAILED DESCRIPTION OF THE INVENTION

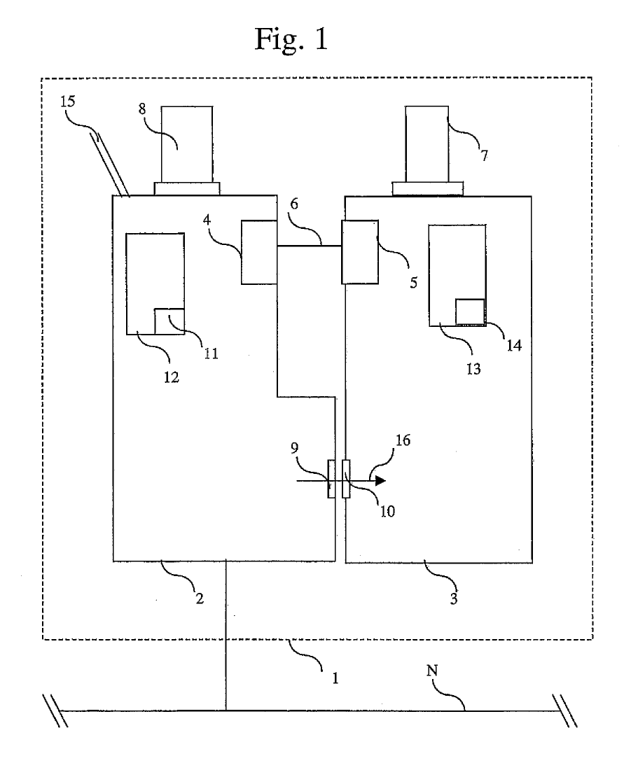

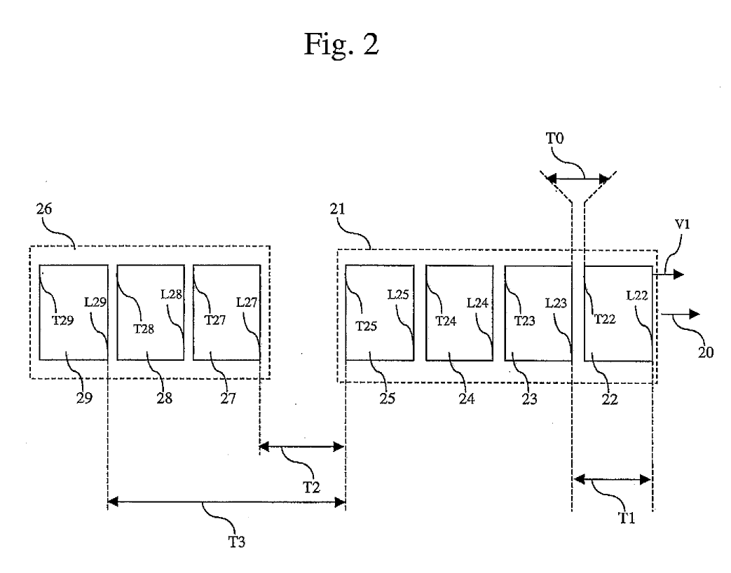

FIG. 1 is a diagram showing a printing apparatus 1 comprising a print module 2, connected to a network N, a finishing module 3, a print interface 4 in the print module 2, a finishing interface 5 in the finishing module 3, a data connection 6 between the print interface 4 and the finishing interface 5, a finishing module console 7, a print module console 8, a sheet outlet 9, a sheet inlet 10, a printer memory 12 in the print module 2, a finisher memory 13 in the finishing module 3, a lookup table 11 being part of the printer memory 12 in the print module 2, a lookup table 14 being part of the finisher memory 13 in the finishing module 3 and an automatic document feeder 15 on the print module 2. The print interface 4 and the finishing interface 5 are configured to exchange digital information about delivery timing parameters, which delivery timing parameters are needed for an errorless printing process, an errorless flow of sheets from the print module towards the finishing module and an errorless finishing process, explained hereinafter with reference to FIG. 2. Among these delivery timing parameters, according to an embodiment of the present invention, three delivery timing parameters TP1, TP2 and TP3 may be present. Values of the delivery timing parameters TP1, TP2 and TP3 may be entered via finishing module console 7 and stored in the finisher memory 13 of the finishing module 3. Values of the delivery timing parameters TP1, TP2 and TP3 may also be entered via print module console 8 and stored in the printer memory 12 of the print module 2.

When a set arrives at the printing apparatus via a network N or via an automatic document feeder 15 of the print module 2 the delivery timing parameters may be selected from the collection of delivery timing parameters stored in the finisher memory 13 of the finishing module 3 and transformed into digital information. For each kind of printing and finishing, values have to be entered only once. For example, in an embodiment only two possible values have been stored for each of the three delivery timing parameters TP1, TP2 and TP3, transforming may be achieved by using digital information comprising only three bits, each bit having a value one or zero, such that the value may correspond to one of the two possible values of one of the three delivery timing parameters TP1, TP2 and TP3. The digital information is passed from the finishing module 3 via the finishing module interface 5, the data connection 6 and the print module interface 4 to the print module. The data connection 6 may be a communication cable, a wireless connection, infrared beams or any other data communication means. Before the set is printed by the print module 2, the digital information is transformed, for example by means of a lookup table 1 1 in the printer memory 12 of the print module 2, into the determined values of the delivery timing parameters TP1, TP2 and TP3 and the printing of the set starts taking into account the determined values of the delivery timing parameters TP1, TP2 and TP3. A printed sheet of the set arrives at the sheet outlet 9 just in time to enter the finishing module 3 via the sheet inlet 10, the sheet flow direction indicated by arrow 16.

The inter sheet and set timing is illustrated in FIG. 2. Sheets leave the print module 2 at the sheet outlet 9 with an output speed V1 and an interval time T0 between the trailing edge of a sheet of a set and the leading edge of the subsequent sheet of the same set. It is desirable that the processing speed of the print module 2, which speed may be equal to the output speed V1 of each sheet of the print module, is adapted to the capabilities of the finishing module 3. As described, delivery timing parameters TP1, TP2 and TP3 are communicated between the print module 2 and the finishing module 3. In FIG. 2 two sets of sheets are shown. A first set 21 consists of sheets 22, 23, 24 and 25. A subsequent second set 26 consists of sheets 27, 28 and 29. The first sheet 22 has a first leading edge L22 and a first trailing edge T22, the second sheet 23 has a second leading edge L23 and a second trailing edge T23, the third sheet 24 has a third leading edge L24 and a third trailing edge T24, the fourth sheet 25 has a fourth leading edge L25 and a fourth trailing edge T25, the fifth sheet 27 has a fifth leading edge L27 and a fifth trailing edge T27, the sixth sheet 28 has a sixth leading edge L28 and a sixth trailing edge T28 and the seventh sheet 29 has a seventh leading edge L29 and a seventh trailing edge T29. A delivery timing parameter TP1 corresponds to a first time interval T1, being a time interval between the receipt by the finishing module 3 of the first leading edge L22 of the first sheet 22 and the second leading edge L23 of the subsequent second sheet 23. A delivery timing parameter TP2 corresponds to a second time interval T2, being a time interval between the receipt by the finishing module 3 of the fourth trailing edge T25 of the fourth sheet 25, being the last sheet of the first set 21, and the fifth leading edge L27 of the fifth sheet 27, being the first sheet of the subsequent second set 26. A delivery timing parameter TP3 corresponds to a third time interval T3, being a time interval between the receipt by the finishing module of the fourth trailing edge T25 of the fourth sheet 25, being the last sheet of the first set 21, and the seventh leading edge L29 of the seventh sheet 29, being the last sheet of the subsequent second set 26. The time intervals T1, T2 and T3 are indicated by respective double-sided arrows. An arrow 20 shows a transportation direction in which the sheets leave the sheet outlet 9 and enter the sheet inlet 10, the sheet inlet at which the receipt by the finishing module 3 occurs.

The first time interval T1 has such a value that the finishing module is able to handle subsequent sheets in a set, for example the first sheet 22 of the first set 21 and the subsequent second sheet 23 of the first set 21. If the time interval between the receipt by the finishing module 3 of the first leading edge L22 of the first sheet 22 and the second leading edge L23 of the subsequent second sheet 23 is less than the first time interval T1, the finishing module 3 is not ready to handle the second sheet 23. If the time interval between the receipt by the finishing module 3 of the first leading edge L22 of the first sheet 22 and the second leading edge L23 of the subsequent second sheet 23 is equal to or greater than the first time interval T1, the finishing module is able to process the subsequent second sheet 23 of the first set 21.

The second time interval T2 has such a value that the finishing module is able to handle subsequent sets of sheets in case of consecutive processing of sets by the finishing module 3. For example the first set 21 and the subsequent second set 26 are processed in the chain “printing-finishing”. If the time interval between the receipt by the finishing module 3 of the fourth trailing edge T25 of the fourth sheet 25 of the first set 21 and the fifth leading edge L27 of the fifth sheet 27, begin the first sheet of the subsequent second set 26, is less than the second time interval T2, the finishing module 3 may still busy with the finishing process of the first set 21. If the finishing module 3 is configured for consecutive processing of sets, the finishing module 3 is not able to start the finishing process of the subsequent second set 26 and paper jam or any other error may occur. If the time interval between the receipt by the finishing module 3 of the fourth trailing edge T25 of the fourth sheet 25 of the first set 21 and the fifth leading edge L27 of the fifth sheet 27, being the first sheet of the subsequent second set 26, is equal to or greater than the second time interval T2, the finishing module 3 is able to process the subsequent second set 26. An example of a finishing module 3 configured in this way may be a booklet-maker, which may need a certain time to staple and fold a booklet while it is not able to receive sheets of the subsequent set.

The third time interval T3 has such a value that the finishing module is able to handle subsequent sets of sheets in case of parallel processing of sets by the finishing module 3. For example the first set 21 and the subsequent second set 26 are processed in the chain “printing-finishing”. If the time interval between the receipt by the finishing module 3 of the fourth trailing edge T25 of the fourth sheet 25 of the first set 21 and the seventh leading edge L29 of the seventh sheet 29, being the last sheet of the subsequent second set 26, is less than the third time interval T3, the finishing module 3 may still busy with the finishing process of the first set 21. If the finishing module 3 is configured for parallel processing of sets, the finishing module 3 is able to start the finishing process of the subsequent second set 26 and may have started this finishing process. If the first set is not finished when a third set (not shown) arrives at the finishing module a paper jam inside the finishing module may be the result. If the time interval between the receipt by the finishing module 3 of the fourth trailing edge T25 of the fourth sheet 25 of the first set 21 and the seventh leading edge L29 of the seventh sheet 29, being the last sheet of the subsequent second set 26, is equal to or greater than the third time interval T3, the finishing module 3 is able to process the subsequent second set 26. An example of a finishing module 3 configured in this way may be a glue-binder, which may need a certain time to glue the first set 21 while it can receive sheets of the subsequent second set 26.

The invention being thus described, it will be obvious that the same may be varied in many ways. Such variations are not to be regarded as a departure from the scope of the invention, and all such modifications as would be obvious to one skilled in the art are intended to be included within the scope of the following claims.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for printing one or more sets, each set comprising at least a first and a second sheet of a receiving medium, each sheet having a leading edge and a trailing edge, and for carrying out user selectable finishing operations on said one or more sets, the method comprising the steps of
storing at least one predetermined delivery timing parameter in a finisher memory of a finishing module, said at least one delivery timing parameter being predetermined by a period of time determined by the receipt by the finishing module of one of the leading edge and trailing edge of a first sheet of the one or more sets and by the receipt of one of the leading edge and the trailing edge of a second sheet of the one or more sets,
storing a copy of said at least one predetermined delivery timing parameter in a printer memory of a print module,
printing a set of said one or more sets on the print module while taking said at least one predetermined delivery timing parameter into account, and
finishing said set of said one or more sets on the finishing module while taking said at least one predetermined delivery timing parameter into account.

2. The method according to claim 1, wherein a first delivery timing parameter corresponds to a period of time between a receipt by the finishing module of the leading edge of a sheet of a first set of the one or more sets and the leading edge of a subsequent sheet of said first set.

3. The method according to claim 2, wherein a value of the first delivery timing parameter is selected from a group comprising a minimum value and an optional value.

4. The method according to claim 1, wherein a second delivery timing parameter corresponds to a period of time between a receipt by the finishing module of the trailing edge of a last sheet of a set of the one or more sets and the leading edge of a first sheet of a subsequent set of said one or more sets.

5. The method according to claim 4, wherein a value of the second delivery timing parameter is selected from a group comprising a minimum value and an optional value.

6. The method according to claim 4, wherein a third delivery timing parameter corresponds to a period of time between the receipt by the finishing module of the trailing edge of a last sheet of a set of the one or more sets and the leading edge of a last sheet of a subsequent set of said one or more sets.

7. The method according to claim 6, wherein a value of the third delivery timing parameter is selected from a group comprising a minimum value and an optional value.

8. The method according to claim 1, wherein the finisher memory comprises a number of finisher memory locations, each finisher memory location storing at least one predetermined delivery timing parameter, and the printer memory comprises a number of printer memory locations, each printer memory location being associated with a finisher memory location and each printer memory location storing a copy of the at least one predetermined delivery timing parameter stored in the associated finisher memory location, the method further comprising the steps of
defining for each finisher memory location a reference parameter referring to said finisher memory location,
passing the at least one reference parameter from the finishing module to the print module, before the printing of a set and
identifying for each reference parameter the corresponding printer memory location associated with said finisher memory location.

9. The method according to claim 1, wherein the printer memory comprises a number of printer memory locations, each printer memory location storing at least one predetermined delivery timing parameter, and the finisher memory comprises a number of finisher memory locations, each finisher memory location being associated with a printer memory location and each finisher memory location storing a copy of the at least one predetermined delivery timing parameter stored in the associated printer memory location, the method further comprising the steps of
defining for each printer memory location a reference parameter referring to said printer memory location,
passing the at least one reference parameter from the printer module to the finishing module, before the printing of a set, and
identifying for each reference parameter the corresponding finisher memory location associated with said printer memory location.

10. The method according to claim 8, wherein the at least one reference parameter being passed comprises a number of digits suitable for identifying the number of locations in the finisher memory and the corresponding locations in the printer memory.

11. The method according to claim 10, wherein the number of digits is selected as small as possible.

12. A printing apparatus, comprising
a print module and finishing module, and
the print module comprising a printer memory for storing at least one predetermined delivery timing parameter and being configured for printing a set while taking said at least one predetermined delivery timing parameter into account, the finishing module comprising a finisher memory for storing said at least one predetermined delivery timing parameter and being configured for finishing said set while taking said at least one predetermined delivery timing parameter into account.

13. A print module comprising a printer memory for storing at least one predetermined delivery timing parameter and being configured for printing a set while taking said at least one predetermined delivery timing parameter into account, said print module being configured for use in the printing apparatus of claim 12.

14. A finishing module comprising a finisher memory for storing at least one predetermined delivery timing parameter and being configured for finishing a set while taking said at least one predetermined delivery timing parameter into account, said finishing module being configured for use in the printing apparatus of claim 12.
